(19) United States
(12) Patent Application Publication
(10) Pub. No.: US 2008/0094130 A1
(43) Pub. Date: Apr. 24, 2008

(54) SUPPLY-INDEPENDENT BIASING CIRCUIT

(75) Inventors: Uei-Shan Uang, Taichung (TW); Shih-Hsuan Hsu, Taipei (TW); Yan-Hua Peng, Miaoli (TW)

Correspondence Address: WPAT, PC, 7225 BEVERLY ST., ANNANDALE, VA, 22003, US

(73) Assignee: FARADAY TECHNOLOGY CORPORATION, Hsinchu (TW)

(21) Appl. No.: 11/751,379

(22) Filed: May 21, 2007

(30) Foreign Application Priority Data
Oct. 19, 2006 (TW) 095138638

(51) Int. Cl. G05F 1/08

(52) U.S. Cl. 327/539

(57) ABSTRACT

A supply-independent biasing circuit applied to a bandgap reference circuit or a proportional to absolute temperature (PTAT) current generating circuit. The bandgap reference circuit or the PTAT current generating circuit includes a mirroring circuit, an operation amplifier, and an input circuit. The mirroring circuit including a plurality of first type FETs. The operation amplifier includes a first type FET connecting to a current input terminal of the operation amplifier. And, the supply-independent biasing circuit includes a first type FET having a gate connected to gates of the first type FETs in the mirroring circuit and having a drain acted as an output current path; and, a current mirror including a plurality of second type FETs and having a current receiving terminal connected to the output current path and having a current outputting terminal connected to the current input terminal of the operation amplifier.

### FIELD OF THE INVENTION

The present invention relates to a supply-independent biasing circuit, and more particularly to a supply-independent biasing circuit applied to a bandgap reference circuit or a proportional to absolute temperature (“PTAT”) current generating circuit.

### BACKGROUND OF THE INVENTION

As known in the art, a bandgap reference circuit provides a steady reference voltage that will not be varied by manufacturing process, temperature or the supplying voltage. In the hybrid circuit field, the bandgap reference circuit is designed into many circuits such as voltage regulators, digital to analog converters or low drift amplifier.

Please refer to FIG. 1A, which illustrates a conventional bandgap reference circuit implemented by PMOS FETs, PNP BJTs and an operation amplifier. Generally speaking, the bandgap reference circuit includes a mirroring circuit 10, an operation amplifier 15 and an input circuit 20. The mirroring circuit 10 comprises two PMOS FETs, M1 and M2. In this example, M1 and M2 have the same length to width ratio (W/L), and the gates of M1 and M2 are connected to each other and the sources of M1 and M2 are connected to a power supply (Vss). The drains of M1 and M2 output current Iₓ and I_{y} respectively. Also, an output terminal of the operation amplifier 15 is connected to the gates of M1 and M2 while a positive input terminal of the operation amplifier 15 is connected to the drain of M1. A second resistor (R₂) is connected between a negative input terminal of the operation amplifier 15 and the drain of M2 to be a load. The operation amplifier 15 has a current input terminal (Iᵢₙ), which receives a biasing current to enable the operation amplifier 15 work under such biasing current.

The input circuit 20 comprises two PNP BJTs, Q1 and Q2. The aspect ratio of Q1 is m times larger than of Q2. The bases and collectors of Q1 and Q2 are connected to the ground to make Q1 and Q2 form diode connections. The emitter of Q2 is connected to the negative input terminal of the operation amplifier 15. A first resistor (R1) is connected between the emitter of Q1 and the positive of the operation amplifier 15. For practical application, the input circuit 20 can be realized by either BJTs combined with a resistor or FETs combined with a resistor.

As shown in FIG. 1A, since M1 and M2 have the same length to width ratio, the current I_{y} and Iₓ outputted by the M2 and M1 are the same. That is Iₓ=I_{y}—(1).

Further, under the premise that the operation amplifier 15 has an infinite gain, a voltage difference between the positive and negative input terminal of the operation amplifier 15 will be the same. That is Vy=Vx. Thus, R₁Iₓ+V_{EB1}=V_{EB2}—(2)

Since Q1 and Q2 form diode connections and the aspect ratio of Q1 is m times larger than Q2,

$${I}_{x} = {mI}_{s} {e}^{\frac{{V}_{EB 1}}{{V}_{T}}} \text{and} {I}_{y} = {I}_{s} {e}^{\frac{{V}_{EB 2}}{{V}_{T}}} ,$$

which derive V_{BE1}=V_{T}ln(Iₓ/mIₛ)—(3), and V_{BE2}=V_{T}ln(I_{y}/Iₛ)—(4), can be obtained; where the Iₛ is a saturation current of Q2 and the V_{T} is a thermal voltage. Finally, combining equations of (1), (2), (3) and (4), the current Iₓ=(1/R₁)V_{T}ln m—(5), and the reference voltage V_{ref}=(R₂/R₁)V_{T}ln m+V_{EB2}—(6) are obtained.

As known in the art, the current Iₓ or I_{y} have a characteristic of positive temperature coefficient and the V_{EB2} of Q2 has a characteristic of negative temperature coefficient, that means the summation of the two items in equation (6) to be any value with zero temperature coefficient. That is to say, under any temperature the reference voltage (V_{ref}) can almost always be a fixed value.

Please refer to FIG. 1B, which illustrates a conventional bandgap reference circuit implemented by NMOS FETs, NPN BJTs and an operation amplifier. The mirroring circuit 10 of the bandgap reference circuit comprises two NMOS FETs, M1′ and M2′. The input circuit 20 comprises two NPN BJTs Q1′ and Q2′; in which, M1′ and M2′ have the same length to width ratio (W/L); and the aspect ratio of Q1′ is m times larger than Q2′. Through the same derivation as with FIG. 1A, the reference voltage V_{ref}=−(R₂/R₁)V_{T}ln m−V_{BE2′} can be obtained.

Please refer to FIG. 2A, which illustrates another conventional bandgap reference circuit implemented by PMOS FETs, PNP BJTs and an operation amplifier. Comparing with the bandgap reference circuit illustrated in FIG. 1A, the mirroring circuit 12 comprises three PMOS FETs, M1, M2 and M3; the gates of M1, M2 and M3 are connected to each other. The sources of M1, M2 and M3 are connected to the power supply (Vss). The drains of M1, M2 and M3 output currents Ix, Iy and Iz respectively. A third resistor (R3) is connected between the drain of M3 and the emitter of Q3. The base and collector of Q3 are connected to the ground to form the diode connection. Also, Q3 and Q2 have the same layout area. The output terminal of the operation amplifier 15 is connected to the gate of M1. The positive terminal of the operation amplifier 15 is connected to the drain of M1 and the negative input terminal is connected to the drain of M2. Further, the input circuit 20 is the same as the input circuit 20 in FIG. 1A.

By the same logic, currents Ix, Iy, and Iz are the same. That is Ix=Iy=Iz. Thus, the reference voltage V_{ref}=(R₃/R₁)V_{T}ln m+V_{EB3} that will not vary with temperature can be obtained.

Please refer to FIG. 2B, which illustrates another bandgap reference circuit implemented by NMOS FETs, PNP BJTs and an operation amplifier. The mirroring circuit 12 comprises three NMOS FETs, M1′, M2′ and M3′. The input circuit 20 comprises two PNP BJTs Q1′ and Q2′; in which, M1′ and M2′ have the same length to width ratio (W/L) and the layout area of Q1′ is m times of that of Q2′. Through the same derivation as FIG. 2A, the reference voltage V_{ref}=−(R₃/R₁)V_{T}ln m−V_{BE3′} can be obtained.

A proportional to absolute temperature (PTAT) current generating circuit is also widely designed in hybrid circuit to produce a current that varies according to temperature. Please refer to FIG. 3A, which illustrates a conventional PTAT current generating circuit implemented by PMOS FETs, PNP BJTs and an operation amplifier. The structure of PTAT current generating circuit is similar to the bandgap reference circuit illustrated in FIG. 2A; the only difference being that the drain of PMOS FET M3 directly outputs PTAT current (Iₚₜₐₜ). The connection of the operation amplifier 15 and the input circuit 20 are the same as that in FIG. 2A.

By the same logic, three currents Iₓ, I_{y}, and Iₚₜₐₜ are the same. That is Iₓ=I_{y}=Iₚₜₐₜ. Thus, a PTAT current Iₚₜₐₜ=(1/R₁)V_{T} ln m can be obtained. According to the characteristic that the current of BJT is proportional to absolute temperature, the PTAT current generating circuit can be obtained by modifying the conventional bandgap reference circuit.

Please refer to FIG. 3B, which illustrates the conventional PTAT current generating circuit implemented by NMOS FETs, NPN BJTs and an operation amplifier. Through the same derivation as that in FIG. 3A, the PTAT current Iₚₜₐₜ=(1/R₁)V_{T} ln m is obtained.

The above described bandgap reference circuits and PTAT current generating circuits assume that the operation amplifier 15 has an infinite gain (or a larger gain that can be stably maintained to allow the voltage difference between positive and negative input terminal be seen as zero). For practical applications, op amps are biased by noise supply voltage. In order to make the operation amplifier 15 insusceptible to the power supply, the conventional bandgap reference circuit and PTAT current generating circuit uses a supply-independent biasing circuit that produces a stable biasing current to the current input terminal (Iᵢₙ) of the operation amplifier 15. As implied by the name, when the power supply changes, the supply-independent biasing circuit can still provide a stable biasing current to the operation amplifier 15, hence a high and stable gain of the operation amplifier is maintained, thereby enables the bandgap reference circuit and the PTAT current generating circuit to work normally.

It is known in the art, the supply-independent biasing circuit is realized by using a constant-transconductance circuit (constant-gm circuit). Please refer to FIG. 4A, which illustrates a constant-gm circuit, in which two PMOS FETs, M4 and M5 have the same length to width ratio (W/L). And, a length to width ratio (W/L) of M6 is K times that of M4. M4, M5 and M6 are connected together to form the structure of a current mirror, in which the gates of M4, M5 and M6 are connected to each other. The drains of M4, M5 and M6 are connected to the power supply (Vss). The gate and drain of M4 are connected to each other and the drains of M4, M5 output currents I1 and I2 respectively. Among the three NMOS FETs, M7, M8 and M9, length to width ratios (W/L) of M7 and M9 are k times of that of M8. The gates of M7, M8 and M9 are connected to each other. The sources of M8 and M9 are connected to the ground and a resistor R4 is connected between the source of M7 and the ground. The drains of M4 and M7 are connected to each other; and the drains of M5 and M8 are connected to each other.

As can be known from FIG. 4A, since M4 and M5 have the same aspect ratio (W/L), the output current (I₁) of M4 is the same as the output current (I₂) of M5. That is I₁=I₂—(7). Further, from the connection of R4, M7 and M8, the equation R₄I₁+V_{GS7}=V_{GS8}—(8) can be derived. Also, Since M7 and M8 are operated in the saturation region, I₁=(½)μₙCₒₓk(W/L)ₙ(V_{GS7}−Vₜₕ)² and I₂=(½)μₙCₒₓ(W/L) (V_{GS8}−Vₜₕ)² can be derived, therefore

$${V}_{GS 7} = {V}_{th} - \sqrt{\frac{2 {I}_{1}}{{μ}_{n} {C}_{ox} {k ( W / L )}_{n}}} , \qquad ( 9 )$$

$${V}_{GS 8} = {V}_{th} - \sqrt{\frac{2 {I}_{2}}{{μ}_{n} {C}_{ox} {k ( W / L )}_{n}}} ; \qquad ( 10 )$$

in which, μₙ is an electron mobility, Cₒₓ is an oxide capacitance, and Vₜₕ is a threshold voltage. Combining equation (7), (8), (9) and (11), I₁=0 or

$${I}_{1} = \frac{2}{{μ}_{n} {{C}_{ox} ( W / L )}_{n}} \cdot \frac{1}{{R}_{4}^{2}} {( 1 - \frac{1}{\sqrt{k}} )}^{2} \qquad ( 11 )$$

can be derived.

Thus, the intersections of the curves plotted in FIG. 4B is the solution of equations (7) and (8). In other words, constant-gm circuit may result in an undesirable zero biasing current or a stably biasing current as illustrated by equation (11). In order for the constant-gm circuit to output a biasing current as equation (11), a startup circuit 25 is used to force the constant-gm circuit to reach the desired current. Further, as shown by equation (11), this biasing current is independent of power supply and the Transconductance (gm) is (2/R₄)(1−1/\sqrt{k}). When the constant-gm circuit operates normally, the drains of M6 or M9 can provide the stable biasing current to the operation amplifier 15.

Under normal circumstances, the M7 of the constant-gm circuit operates in the saturation region. However, as the power supply becomes smaller, M7 may not remain in the saturation region; and equation (11) no longer stands. This is because equation (11) assumes that all FET operate in the saturation region. If M7 does not operate in the saturation region, then I₁ in equation (11) will vary according to the change in the power supply (Vss), thereby affecting normal operation of the bandgap reference circuit and the PTAT current generating circuit. From this it could be known that, the constant-gm circuit may not be used in a low bias voltage integrated circuit manufactured by an advanced manufacturing process. Furthermore, it is widely known in the IC design field that the fourth resistors in constant-gm circuit will occupy most of the layout area. Generally speaking, the fourth resistors will occupy 90% of the layout area of the constant-gm circuit and consume more power than our present invention. Thus, improvement of a supply-independent biasing circuit is the main purpose of the present invention.

### SUMMARY OF THE INVENTION

The object of the present invention is to provide a supply-independent biasing circuit for providing a stable biasing current when the supplying voltage is lower.

The present invention relates to a supply-independent biasing circuit applied to a bandgap reference circuit or a proportional to absolute temperature current generating circuit, the bandgap reference circuit or the proportional to absolute temperature current generating circuit including a mirroring circuit, an operation amplifier, and an input circuit, the mirroring circuit including a plurality of first type FETs, the operation amplifier including a first type FET connecting to a current input terminal of the operation amplifier, and the supply-independent biasing circuit including: a first type FET having a gate connected to gates of the first type FETs in the mirroring circuit and having a drain acted as an output current path; and, a current mirror including a plurality of second type FETs and having a current receiving terminal connected to the output current path and having a current outputting terminal connected to the current input terminal of the operation amplifier.

Moreover, the present invention relates to a supply-independent biasing circuit applied to a bandgap reference circuit or a proportional to absolute temperature current generating circuit, the bandgap reference circuit or the proportional to absolute temperature current generating circuit including a mirroring circuit, an operation amplifier, and an input circuit, the mirroring circuit including a plurality of first type FETs, the operation amplifier including a second type FET connecting to a current input terminal of the operation amplifier, and wherein the supply-independent biasing circuit is characterized in a first type FET having a gate connected to gates of the first type FETs in the mirroring circuit and having a drain connected to the current input terminal of the operation amplifier.

Moreover, the present invention relates to a reference circuit, including: an input circuit including two terminals; a mirroring circuit including two current paths connected to the two terminals of the input circuit for outputting two currents with a fixed ratio to the two current paths respectively; an operation amplifier having a current input terminal and having two input terminals respectively connected to the two terminal of the input circuit and having an output terminal connected to the mirroring circuit; and, a biasing circuit connected to the mirroring circuit for generating a biasing current in response to one of the two currents outputted by the mirroring circuit to the current input terminal for biasing the operation amplifier.

### BRIEF DESCRIPTION OF THE DRAWINGS

The above contents of the present invention will become more readily apparent to those ordinarily skilled in the art after reviewing the following detailed description and accompanying drawings, in which:

FIG. 1A illustrates a conventional bandgap reference circuit implemented by PMOS FETs, PNP BJTs and an operation amplifier.

FIG. 1B illustrates a conventional bandgap reference circuit implemented by NMOS FETs, NPN BJTs and an operation amplifier.

FIG. 2A illustrates another conventional bandgap reference circuit implemented by PMOS FETs, PNP BJTs and an operation amplifier.

FIG. 2B illustrates another bandgap reference circuit implemented by NMOS FETs, PNP BJTs and an operation amplifier.

FIG. 3A illustrates a conventional PTAT current generating circuit implemented by PMOS FETs, PNP BJTs and an operation amplifier.

FIG. 3B illustrates the conventional PTAT current generating circuit implemented by NMOS FETs, NPN BJTs and an operation amplifier.

FIG. 4A illustrates a constant-gm circuit.

FIG. 4B is curves diagram related to the solution of equations (7) and (8).

FIG. 5A illustrates a two-stage CMOS operation amplifier.

FIG. 5B illustrates another two-stage CMOS operation amplifier.

FIG. 6A illustrates the first embodiment of the supply-independent biasing circuit.

FIG. 6B illustrates the second embodiment of the supply-independent biasing circuit.

FIG. 6C illustrates the third embodiment of the supply-independent biasing circuit.

FIG. 6D illustrates the fourth embodiment of the supply-independent biasing circuit.

FIG. 7 illustrates the relation between the biasing current and the supplying voltage of the presently invented biasing circuit and the conventional constant-gm circuit.

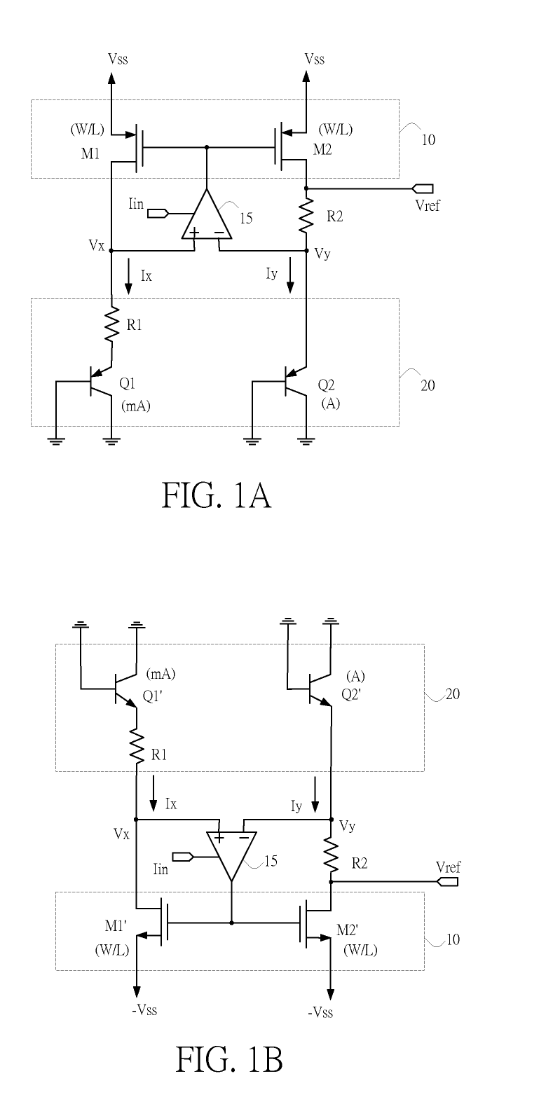

### DETAILED DESCRIPTION OF THE PREFERRED EMBODIMENT

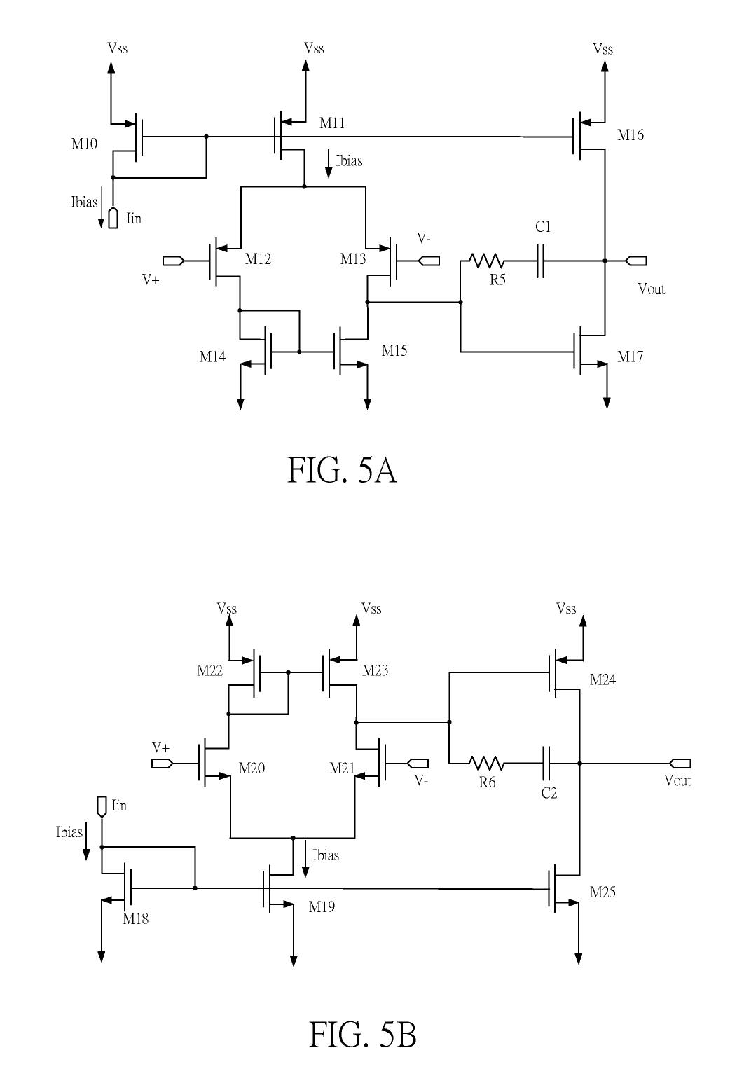

In IC design field, the operation amplifier can be realized by N-FET and P-FET. Please refer to FIG. 5A, which illustrates a two-stage CMOS operation amplifier, in which, current input terminal (Iᵢₙ) can provide a biasing current I_{bias} to the drain of M10 in the operation amplifier. As M10 and M11 are current mirror, M11 can generate the biasing current to the input stage. In which, the input stage is an active-loaded differential amplifying circuit composed of transistors M12 to M15. The gates of M12 and M13 are the positive input terminal (V+) and negative input terminal (V−) respectively. The output stage is composed of transistor M16 and M17; a fifth resistor (R5) is used as a compensating resistor; the first capacitor (C1) is used as the miller feedback capacitor for frequency compensation; and the connecting point of transistors M16 and M17 is the output terminal (Vout) of the operation amplifier.

Please refer to FIG. 5B, which illustrates another two-stage CMOS operation amplifier; in which, current input terminal (Iᵢₙ) can receive a biasing current (I_{bias}) to the operation amplifier. As M10 and M11 are current mirror, thus M11 can produce the biasing current to the input stage. The input stage is an active-loaded differential amplifying circuit composed of transistors M20 to M23. The gates of transistor M20 and M21 are the positive input terminal (V+) and negative input terminal (V−) respectively. The output stage is composed of transistors M24 and M25; a sixth resistor (R6) is used as a compensating resistor; the second capacitor (C2) is used as the miller feedback capacitor for frequency compensation; and the connecting point of transistors M24 and M25 is output terminal (Vout) of the operation amplifier.

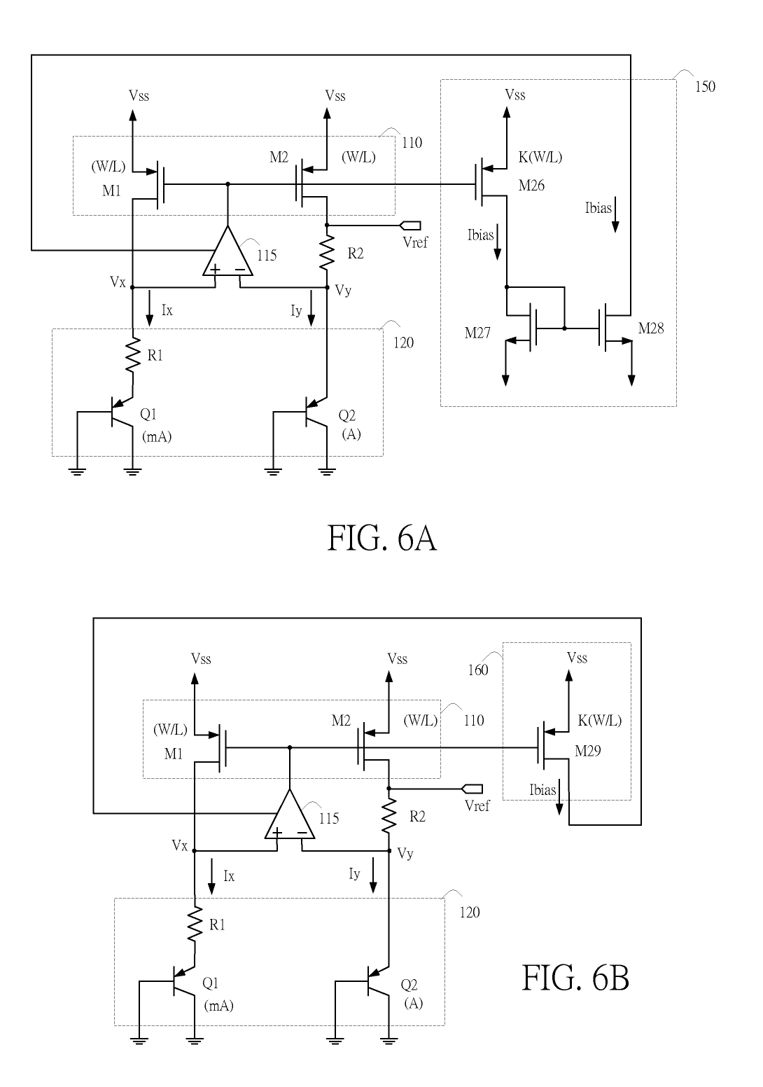

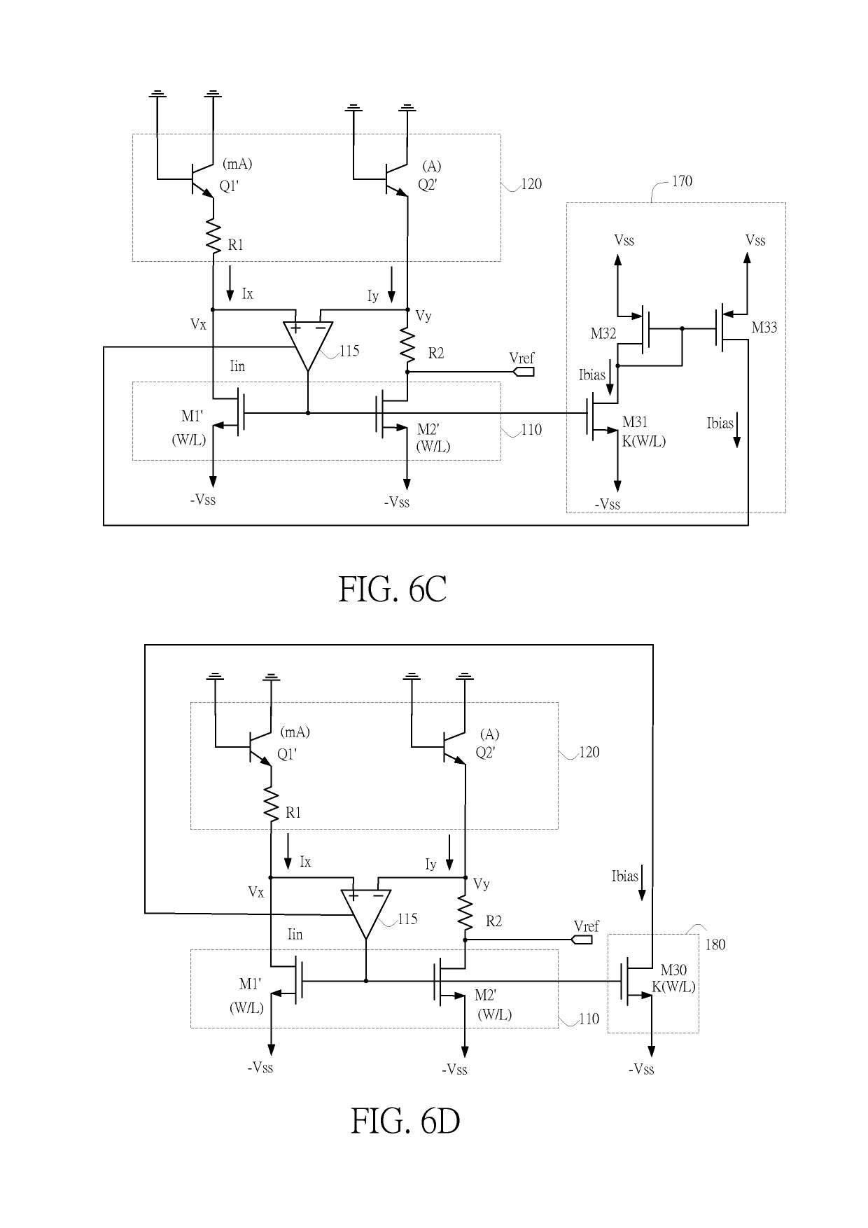

The supply-independent biasing circuit of the present invention is realized according to the mirroring circuit of the bandgap reference circuit or the PTAT current generating circuit and the type of the operation amplifier. Please refer to FIG. 6A, which illustrates the first embodiment of the present invention. In the first embodiment, the mirroring circuit 110 of the bandgap reference circuit comprises PMOS FET; while the current input terminal of operation amplifier 115 is connected to a PMOS FET as illustrated in FIG. 5A.

As illustrated, the biasing circuit 150 in the first embodiment has a PMOS FET (M26); the gate of M26 is connected to the gates of M1 and M2 in mirroring circuit 110 and the source of M26 is connected to the power supply (Vss). Thus, the drain of M26 can be seen as a current output path. The current of the output path is proportional to the currents Ix and Iy of mirroring circuit 110. In the first embodiment, M1 and M2 have the same length to width ratio and the ratio of M26 is k times that of M1, so Ibias=kIx=kIy (k may be bigger or smaller than 1) can be derived. Further, the biasing circuit 150 of the first embodiment includes a current mirror composed of NMOS FETs, M27 and M28, and a current receiving terminal of the current mirror is connected to the current output path of M26. Also, a current outputting terminal is connected to the current input terminal of the operation amplifier 115 to enable the current input terminal to receive the biasing current (I_{bias}).

When the mirroring circuit 110 is composed of PMOS FET and the current input terminal of the operation amplifier 115 is connected to a PMOS FET, the biasing circuit 150 of the first embodiment can be used to generate the biasing current (I_{bias}) into the operation amplifier 115. The biasing current (I_{bias}) generated by the biasing circuit 150 is I_{bias}=K(1/R₁)V_{T} ln m. Obviously, this biasing current (I_{bias}) is not a function of power supply (Vss), therefore when the power supply varies, the biasing circuit 150 can provide a stable biasing current to the operation amplifier 115.

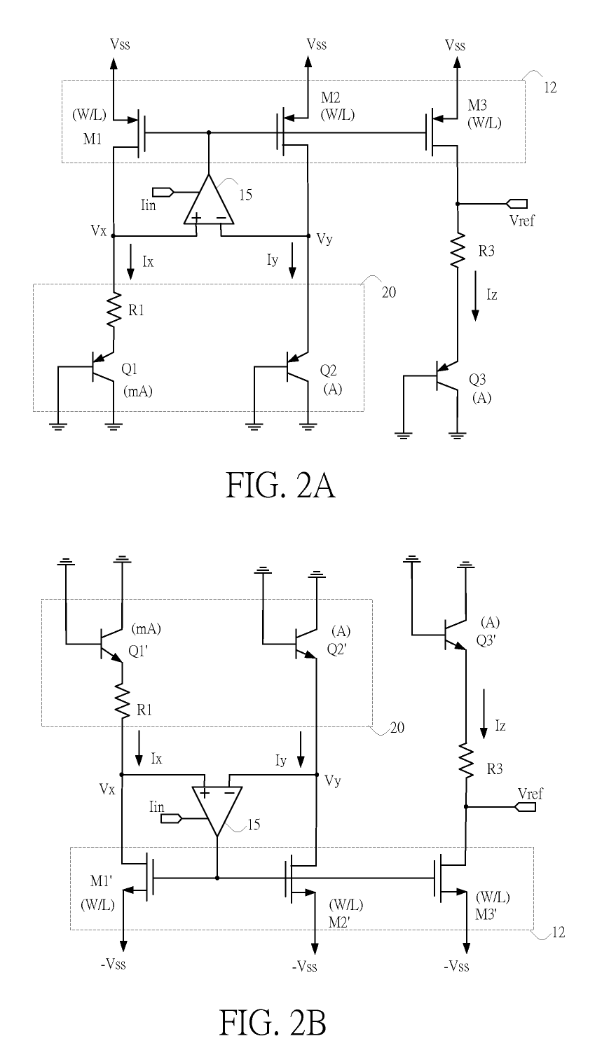

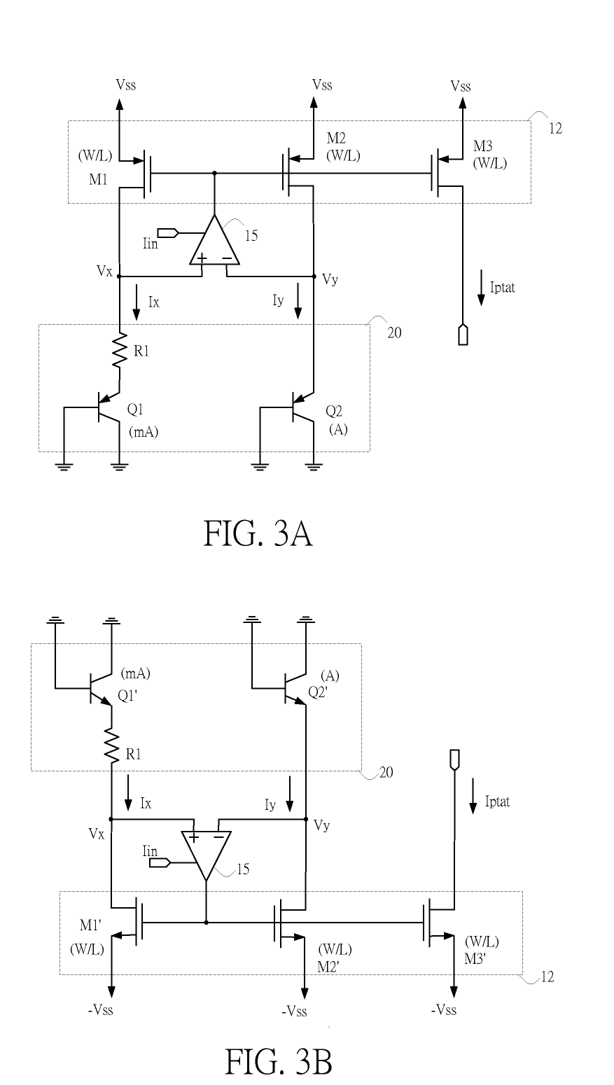

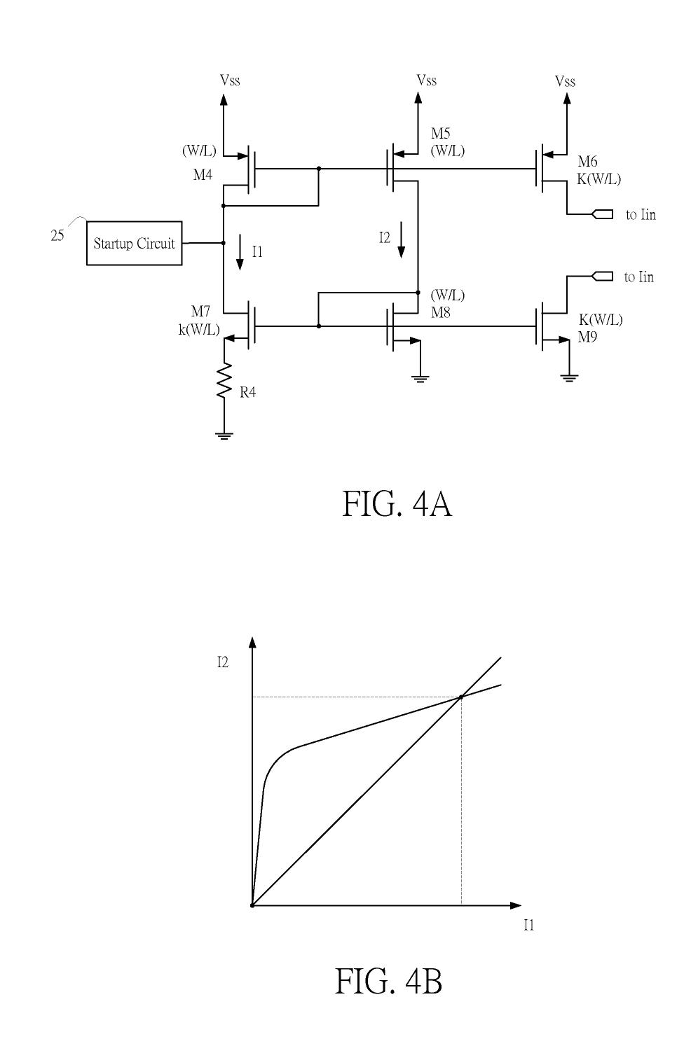

The biasing circuit disclosed in the first embodiment can be used on other kinds of bandgap reference circuits or PTAT current generating circuits. Take the bandgap reference circuit illustrated in FIG. 2A and PTAT current generating circuit illustrated in FIG. 3A as examples, when the mirroring circuit is composed of PMOS FETs and the current input terminal of the operation amplifier is connected to a PMOS FET, the same biasing circuit 150 can be selected. In practical application, other than BJTs combined with a resistor, the input circuit 120 can be realized by FETs combined with a resistor. That is to say, the present invention is not limited to the elements and structure of the input circuit 120.

Please refer to FIG. 6B, which illustrates the second embodiment of the supply-independent biasing circuit. In the second embodiment, the mirroring circuit 110 of the bandgap reference circuit comprises PMOS FETs; and the current input terminal of the operation amplifier 115 is connected to a NMOS FET as illustrated in FIG. 5B.

As shown in the illustration, the biasing circuit 160 in the second embodiment has an additional a PMOS FET (M29). The gate of M29 is connected to the gates of the PMOS FETs, M1 and M2, in the mirroring circuit 110, and the source of M29 is connected to the power supply (Vss). Thus, the drain of PMOS FET (M29) can be seen as a current output path. The current of this output path is proportional to the current Ix and Iy outputted by the mirroring circuit 110. Since M1 and M2 in the second embodiment have the same length to width ratio and the ratio of M29 is k times of that of M1, so Ibias=kIx=kIy (k could be bigger or smaller than 1) can be derived. Furthermore, the output current path of the biasing circuit 160 is directly connected to the current input terminal of the operation amplifier 115 to enable the current input terminal to receive the biasing current (I_{bias}).

When the mirroring circuit 110 comprises PMOS FETs and the current input terminal of the operation amplifier is connected to a NMOS FET, the biasing circuit 160 of the second embodiment can generate the biasing current (I_{bias}) to the operation amplifier 115. The biasing current (I_{bias}) produced by the biasing circuit 160 is I_{bias}=K(1/R₁)V_{T} ln m. Obviously, the biasing current (I_{bias}) is not a function of power supply (Vss), therefore when power supply varies, the biasing circuit 160 can provide a stable biasing current (I_{bias}) to the operation amplifier 115.

Further, the biasing circuit disclosed in the second embodiment can be designed on other kinds of bandgap reference circuits or PTAT current generating circuits. Take the bandgap reference circuit illustrated in FIG. 2A and PTAT current generating circuit illustrated in FIG. 3A as examples, when the mirroring circuit comprises PMOS FETs and the current input terminal of the operation amplifier is connected to a NMOS FET, the same biasing circuit 160 can be selected.

Please refer to FIG. 6C, which illustrates the third embodiment of the supply-independent biasing circuit. In the third embodiment, the mirroring Circuit 110 of the bandgap reference circuit comprises NMOS FETs and the current input terminal of the operation amplifier 115 is connected to a NMOS FET.

As illustrated, the biasing circuit 170 of the third embodiment has a NMOS FET (M31). The gate of M31 is connected to the gates of M1′ and M2′ in the mirroring circuit 110, and the source of M31 is connected to the power supply (−Vss). Thus, the drain of M31 can be seen as a current output path. The current of the current output path is proportional to the currents Ix and Iy outputted by the mirroring circuit 110. M1′ and M2′ in the third embodiment have the same length to width ratio and the ratio of M31 is k times of that of M1′, hence Ibias=kIx=kIy (k may be bigger or smaller than 1) can be derived. Further, the biasing circuit 170 includes the current mirror composed of M32 and M33 and one current receiving terminal of the current mirror is connected to the current path; the current outputting terminal of the current mirror is connected to the current input terminal of the operation amplifier 115 to enable the current input terminal to receive the biasing current.

When the mirroring circuit 110 comprises NMOS FETs and the current input terminal of the operation amplifier is connected to a NMOS FET, the biasing circuit 170 of the third embodiment can produces a biasing current to the operation amplifier 115. The biasing current produced by the biasing circuit 170 is I_{bias}=K(1/R₁)V_{T} ln m. Obviously, the biasing current is not a function of the power supply (−Vss). Therefore, when power supply varies, the biasing circuit 170 can provide a stable biasing current to the operation amplifier 115.

Further, the biasing circuit 170 disclosed in the third embodiment can be designed on other kinds of bandgap reference circuit and PTAT current generating circuits. Take the bandgap reference circuit illustrated in FIG. 2B and the PTAT current generating circuit illustrated in FIG. 3B as examples, when the mirroring circuit comprises NMOS FETs and the current input terminal of the operation amplifier is connected to a NMOS FET, the same biasing circuit 170 can be selected. In practical application, other than BJTs combined with a resistor, the input circuit 120 can be realized by FETs combined with a resistor. Therefore, the present invention is not limited to elements and structure of the input circuit 120.

Please refer to FIG. 6D, which illustrates the fourth embodiment of the supply-independent biasing circuit. In the fourth application, the mirroring circuit 110 of the bandgap reference circuit comprises NMOS FETs and the current input terminal of the operation amplifier 115 is connected to a PMOS FET.

As illustrated, the biasing circuit 180 of the fourth embodiment has an NMOS FET (M30). The gate of M30 is connected to the gates of M1′ and M2′ of the mirroring circuit 110, and the source of M30 is connected to the power supply (−Vss). Thus, the drain of PMOS FET (M30) can be seen as a current output path. The current of the current output path is proportional to the currents Ix and Iy outputted by the mirroring circuit. M1′ and M2′ in the fourth embodiment have the same length to width ratio and the ratio of M30 is k times of that of M1′, hence Ibias=kIx=kIy (k may be bigger or smaller than 1) can be derived. Further, the biasing circuit 180 has its current output path directly connected to the current input terminal of the operation amplifier 115 to enable the current input terminal to receive the biasing current.

When the mirroring circuit 110 comprises NMOS FETs and the current input terminal of the operation amplifier is connected to a PMOS FET. The biasing circuit 180 of the fourth embodiment can generate a biasing current to the operation amplifier 115. The biasing current produced by the biasing circuit 180 is I_{bias}=K(1/R1)V_{T} ln m. Obviously, the biasing current is not a function of the power supply (−Vss). Therefore, when the power supply varies, the biasing circuit 180 can provide a stable biasing current to the operation amplifier 115.

Further, the biasing circuit 180 disclosed in the fourth embodiment can be designed on other kinds of bandgap reference circuits and the PTAT current generating circuits. Take the bandgap reference circuit illustrated in FIG. 2B and the PTAT current generating circuit illustrated in FIG. 3B as examples, when the mirroring circuit comprises NMOS FETs and the current input terminal of the operation amplifier is connected to a PMOS FET, the same biasing circuit 180 can be selected.

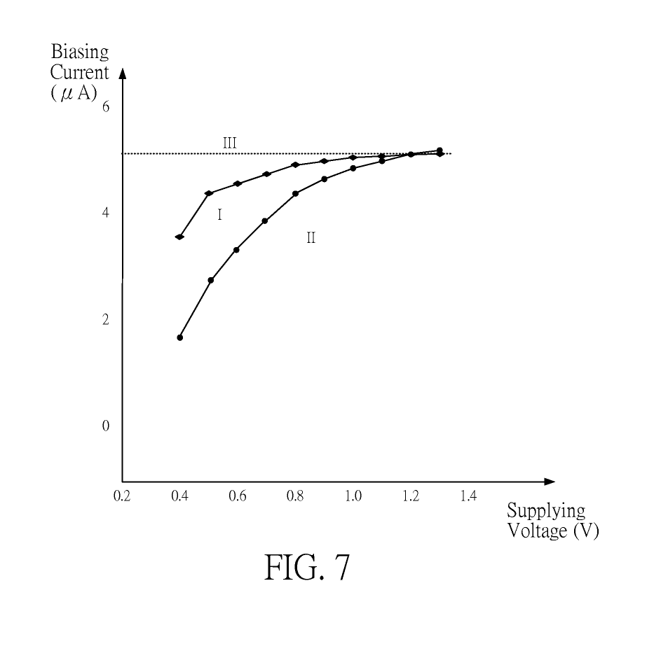

Please refer to FIG. 7, which illustrates the relation between the biasing current and the supplying voltage of the presently invented biasing circuit and the conventional constant-gm circuit. Curve I is I-V characteristic curve of the presently invented biasing circuit; curve II is I-V characteristic curve of the conventional constant-gm circuit and curve III is the ideal I-V characteristic curve (yet unachievable in current practical IC design). As shown from FIG. 7, curve I of the present invention is closest to the ideal curve III. That means the biasing circuit of the present invention can provide much more biasing current to the operation amplifier than the conventional constant-gm circuit under the lower supplying voltage. Comparing with the constant-gm circuit, the biasing circuit of the present invention is more suitable for use under lower supplying voltage, such as an IC manufactured by a deep submicron process. Further, as the disclosed biasing circuit does not compose of any resistant element, from the viewpoint of power consumption, power consumption of the disclosed biasing circuit is much lower than that by the constant-gm circuit; from the viewpoint of circuit layout area, the area of the disclosed biasing circuit is also smaller than the constant-gm circuit.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A supply-independent biasing circuit applied to a bandgap reference circuit or a proportional to absolute temperature current generating circuit, the bandgap reference circuit or the proportional to absolute temperature current generating circuit including a mirroring circuit, an operation amplifier, and an input circuit, the mirroring circuit including a plurality of first type FETs, the operation amplifier including a first type FET connecting to a current input terminal of the operation amplifier, and the supply-independent biasing circuit including:
a first type FET having a gate connected to gates of the first type FETs in the mirroring circuit and having a drain acted as an output current path; and
a current mirror including a plurality of second type FETs and having a current receiving terminal connected to the output current path and having a current outputting terminal connected to the current input terminal of the operation amplifier.

2. The supply-independent biasing circuit of claim 1, wherein all of the first type FETs are PMOS FETs and all of the second type FETs are NMOS FETs.

3. The supply-independent biasing circuit of claim 1, wherein all of the first type FETs are NMOS FETs and all of the second type FETs are PMOS FETs.

4. The supply-independent biasing circuit of claim 1, wherein a current of the output path is proportional to a current outputted by the mirroring circuit.

5. A supply-independent biasing circuit applied to a bandgap reference circuit or a proportional to absolute temperature current generating circuit, the bandgap reference circuit or the proportional to absolute temperature current generating circuit including a mirroring circuit, an operation amplifier, and an input circuit, the mirroring circuit including a plurality of first type FETs, the operation amplifier including a second type FET connecting to a current input terminal of the operation amplifier, and wherein the supply-independent biasing circuit is characterized in a first type FET having a gate connected to gates of the first type FETs in the mirroring circuit and having a drain connected to the current input terminal of the operation amplifier.

6. The supply-independent biasing circuit of claim 5, wherein all of the first type FETs are PMOS FETs and all of the second type FETs are NMOS FETs.

7. The supply-independent biasing circuit of claim 5, wherein all of the first type FETs are NMOS FETs and all of the second type FETs are PMOS FETs.

8. The supply-independent biasing circuit of claim 5, wherein a current of the input current terminal is proportional to a current outputted by the mirroring circuit.

9. A reference circuit, including:
an input circuit including two terminals;
a mirroring circuit including two current paths connected to the two terminals of the input circuit for outputting two currents with a fixed ratio to the two current paths respectively;
an operation amplifier having a current input terminal and having two input terminals respectively connected to the two terminal of the input circuit and having an output terminal connected to the mirroring circuit; and
a biasing circuit connected to the mirroring circuit for generating a biasing current in response to one of the two currents outputted by the mirroring circuit to the current input terminal for biasing the operation amplifier.

10. The reference circuit of claim 9, wherein the biasing circuit is connected to the mirroring circuit for outputting the biasing current being proportional to one of the two currents outputted by the mirroring circuit.

11. The reference circuit of claim 9, wherein a first terminal of the two terminals of the input circuit is provided a voltage drop with a negative temperature coefficient and the mirroring circuit cooperates with the operation amplifier to output the two currents with positive temperature coefficients.

12. The reference circuit of claim 11, wherein the reference circuit is a bandgap reference circuit for generating a reference voltage with zero temperature in response to the voltage drop provided by the input circuit and the two currents outputted by the mirroring circuit.

13. The reference circuit of claim 11, wherein the reference circuit is a proportional to absolute temperature current generating circuit for generating a proportional to absolute temperature current being proportional to one of the two currents outputted by the mirroring circuit.
